(19) United States
(12) Patent Application Publication
(10) Pub. No.: US 2014/0104809 A1
(43) Pub. Date: Apr. 17, 2014

(54) Electronic Flash Device

(71) Applicant: Nissin Industries Ltd., North Point (CN)

(72) Inventor: Tak Wah SHUM, North Point (CN)

(73) Assignee: Nissin Industries Ltd., North Point (CN)

(21) Appl. No.: 14/050,433

(22) Filed: Oct. 10, 2013

(30) Foreign Application Priority Data
Oct. 12, 2012 (JP) 2012-226892

(51) Int. Cl. F21V 29/00

(52) U.S. Cl. CPC F21V 29/004
USPC 362/6

(57) ABSTRACT

An electronic flash device is properly protected from thermal damages without requiring an expensive heat resistant temperature sensor to be mounted on a flash tube thereof. A heat generation accumulated value is incremented by each activation of the flash unit and decremented by elapsing of each unit time. An activation of the flash unit is permitted when the heat generation accumulated value is no more than a prescribed value and is prohibited when the heat generation accumulated value is more than the prescribed value.

### CROSS-REFERENCE TO RELATED APPLICATIONS

This application claims the priority of Japanese Patent Application No. 2012-226892, filed in the Japanese Patent Office on Oct. 12, 2012, the disclosure of which is hereby incorporated by reference herein in its entirety for all purposes.

### TECHNICAL FIELD

The present invention relates to an electronic flash device that is configured to emit flash light in synchronism with a camera shutter, and in particular to an electronic flash device which is protected from thermal damages in both economical and reliable manner.

### PRIOR ART

An electronic flash device is typically configured to emit flash light in synchronism with the opening of a shutter of a camera. See JP2002-311479A, JP2005-115161 and JP2007-178925.

A discharge flash tube used in an electronic flash device, typically consisting of a xenon flash tube, emits heat each time flash light is emitted therefrom, and the heat could excessively increase the temperature of the flash tube when flash light is consecutively emitted for a prolonged period of time. To protect the flash tube from an excessive rise in temperature, the electronic flash device is typically equipped with a protective circuit that monitors the temperature of the interior of the electronic flash device or a component thereof such as an IGBT and a booster capacitor by using a semiconductor temperature sensor mounted on the corresponding component, and prohibits the emission of flash light or extend the interval between successive emissions of flash light for a prescribed period of time once an excessive temperature is detected.

However, the temperature measured by a temperature sensor attached to the IGBT or the booster capacitor does not accurately reflect the temperature of the flash tube. In particular, when flash light is emitted in rapid succession for a prolonged period of time or flash light is emitted for a plurality of times in taking a single shot (high speed sync), the rise is the temperature of the flash tube is so rapid that the temperature measured by the temperature sensor may unacceptably deviate from the actual temperature of the flash tube. Therefore, in those situations, the flash tube may not be adequately protected from thermal stress or thermal damages.

Such a problem can be avoided if a temperature sensor is attached to the flash tube to directly measure the temperature of the flash tube itself. However, the temperature of the flash tube, in particular the temperature of the lead wire thereof, can rise as high as 600° C. Therefore, a normal temperature sensor such as a thermistor temperature sensor and a semiconductor temperature sensor cannot be used, and an expensive temperature sensor that can withstand such a high temperature would be required.

### BRIEF SUMMARY OF THE INVENTION

In view of such problems of the prior art, a primary object of the present invention is to provide an electronic flash device that is properly protected from thermal damages without requiring an expensive temperature sensor.

A second object of the present invention is to provide an electronic flash device that can be properly protected even when operated in rapid succession.

According to the present invention such objects can be accomplished by providing an electronic flash device, comprising: a flash unit including a flash tube for emitting flash light; a flash control unit configured to receive information from a camera and control the flash unit according to the information received from the camera; wherein the flash control unit includes a heat generation value accumulating unit storing a heat generation accumulated value and configured to increment the heat generation accumulated value by each activation of the flash unit and decrement the heat generation accumulated value by elapsing of each unit time, and a heat generation limit control unit configured to permit an activation of the flash unit when the heat generation accumulated value is no more than a prescribed value and prohibit an activation of the flash unit when the heat generation accumulated value is more than the prescribed value.

The amount of heat generated by each activation of the flash unit and the amount of heat dissipated by the elapsing of unit time without the activation of the flash unit can be estimated either experimentally or by heat analysis, and this data can be used to estimate the rise and drop in the temperature of the flash tube. Therefore, the temperature of the flash tube can be accurately estimated without requiring a temperature sensor to be mounted on the flash tube.

The accuracy of this estimation can be enhanced if the heat generation value accumulating unit is configured to increment the heat generation accumulated value by each activation of the flash unit by an incremental value corresponding to an intensity of the particular activation of the flash unit.

This can be easily implemented if the heat generation value accumulating unit is provided with a data table associating the intensity of the activation of the flash unit with a corresponding incremental value.

According to another aspect of the present invention, the heat generation limit control unit is configured to forward a signal to the camera to change a sensitivity of the camera depending on the heat generation accumulated value. For instance, when an activation of the flash unit is prohibited because the heat generation accumulated value has increased beyond the prescribed value, the sensitivity of the camera may be increased. Thereby, the camera may less require flash light or the camera may be able to take pictures without the aid of flash light, and this mitigates the inconvenience of losing flash light owing to the excessive heating of the flash tube. The heat generation limit control unit may also be configured to decrease the sensitivity of the camera toward the normal value when the prohibition of flash light has been kept lifted for a prescribed time period.

### BRIEF DESCRIPTION OF THE DRAWINGS

Now the present invention is described in the following with reference to the appended drawings, in which:

FIG. 1 is a functional block diagram of an embodiment of the electronic flash unit embodying the present invention;

FIG. 2 shows a data table for associating an incremental value fora heat generation accumulated value with an intensity of a flash unit activation;

FIG. 3 is a flowchart showing a heat generation limit routine of the electronic flash unit; and

FIG. 4 is a time chart of changes in the heat generation accumulated value to illustrate the mode of operation of the electronic flash unit according to the present invention.

### DETAILED DESCRIPTION OF THE PREFERRED EMBODIMENT(S)

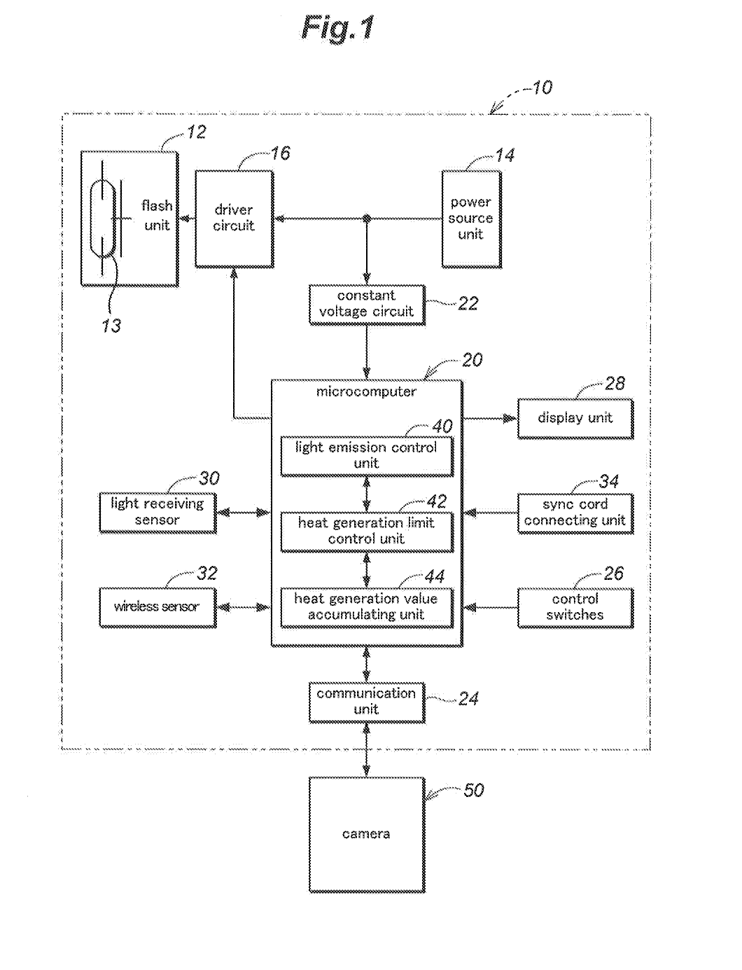

Referring to FIG. 1, an electronic flash device 10 embodying the present invention comprises a flash unit 12, a power source unit 14 including a battery, a driver circuit 16 and a microcomputer 20 for controlling the flash light emission from the flash unit 12.

The flash unit 12 is provided with a xenon discharge tube 13 serving as a light source. To withstand the thermal stress caused by the continuous operation of the discharge tube 13 and ensure a high durability, the xenon discharge tube 13 is encased in a quartz tube, and uses barium as the electron emitting material for the cathode thereof.

The driver circuit 16 includes a DC/DC converter, a main capacitor, a trigger circuit, a switching transistor such as IGBT and so on (not shown in the drawing), and is configured to store the electric energy that is supplied by the power source unit 14 and boosted by the DC/DC converter in the main capacitor, and activate the flash unit 12 at an intensity and at a timing commanded by the microcomputer 20.

The microcomputer 20 is powered by electric power supplied by the power source unit 14 via a constant voltage circuit 22 for controlling the voltage of the supply voltage, and is connected to a communication unit 24, control switches 26, a display unit 28, a light receiving sensor 30, a wireless sensor 32 and a sync cord connecting unit 34.

The communication unit 24 is configured to communicate with an electronic camera 50 when the flash device 10 is fitted into a hot shoe of the camera 50. Camera information (signals) which the communication unit 24 receives from the camera 50 includes TTL light measuring information, shutter speed information, a shutter button signal, a shutter open signal and a shutter close signal.

The control switches 26 are configured to be manipulated by the user, and include a power switch and a multi selection switch for setting various function modes and various manual settings. The function modes that can be set by the multi selection switch includes a TTL auto mode, an external measuring mode, a manual mode, a multi flash mode, an external sync mode, a high sync mode and a wireless TTL mode.

In the TTL auto mode, when the shutter button is pressed, a pre flash by a small amount of light is emitted before opening the shutter, and the intensity of the subsequent main flash is automatically determined from the TTL (through the lens) measurement of the light received by the camera at the time of the pre flash.

When the shutter of the camera consists of a focal plane shutter, for slower shutter speeds, a total exposure takes place after a first curtain has completed the lateral travel and before the second curtain starts the lateral travel. However, for higher shutter speeds, the second curtain follows the lateral movement of the first curtain with a small delay such that the exposure is made through a gap between the first and second curtains which travels across the imaging surface. When the total exposure takes place, a single flash is emitted during the time the shutter is fully open. On the other hand, when the exposure is made by the traveling gap, low intensity flash is successively emitted during the time the traveling gap moves across the imaging surface under the TTL auto light measuring control. This is called as high speed sync.

In the external measuring mode, the main flash starts when the shutter button is pressed and the exposure has started, and the amount of light reflected from the object is measured while the main flash persists. The main flash is eventually terminated when the integrated value of the measured light has a reached a prescribed value.

In the manual mode, a single main flash is emitted by an intensity manually set by the user. The multi flash mode is for taking a picture of an object in rapid succession, and the number of exposures and the intervals as well as the intensity of the main flash are manually selected.

In the external sync mode, the main flash is synchronized with the shutter of the camera for a certain shutter speed (X) by using a sync cord connected between the camera and the flash device without using a hot shoe.

The wireless TTL mode is used when a slave flash device is used in addition to a master flash device which is mounted on the hot shoe of the camera. Shutter button information, shutter information and TTL measurement information are transmitted from the master flash device to the slave flash device via a wireless sensor so that the slave flash device may operate jointly with the master flash device under the TTL auto measurement mode.

The display unit 28 consists of a LCD or the like, and is configured to display a function setting screen, a manual setting screen, etc.

The microcomputer 20 performs the functions of a light emission control unit 40, a heat generation limit control unit 42 and a heat generation value accumulating unit (counter) 44 by executing a computer program.

The light emission control unit 40 determines a flash light emission timing and a flash light emission intensity in each of the various function modes, and forwards a corresponding command signal to the driver circuit 16. In other words, the light emission control unit 40 controls the emission of flash light when the shutter of the camera 50 is open.

The heat generation limit control unit 42 compares a heat generation cumulative value Pc stored in the heat generation value accumulating unit 44 with a prescribed value Pset to forward a permission signal for permitting an activation of the xenon discharge tube 13 when the heat generation cumulative value Pc is no more than the prescribed value Pset, and a prohibition signal for prohibiting an activation of the xenon discharge tube 13 when the heat generation cumulative value Pc is more than the prescribed value Pset.

Thus, the xenon flash tube emits flash light at the prescribed timing and at the required intensity of each function mode when the heat generation cumulative value Pc is no more than the prescribed value Pset, and does not emit flash light when the heat generation cumulative value Pc is more than the prescribed value Pset.

The heat generation value accumulating unit 44 adds a heat generation value Pa which is defined in proportion to the intensity of the flash light emitted from the xenon flash tube to the heat generation cumulative value, and subtracts a heat dissipation value Pb which is defined in proportion to the time duration of the non-active state of the xenon flash tube during which no flash light is emitted. As the cooling of the flash tube does not occur linearly with the progress of time, the heat dissipation value Pb may be greater when the value of the heat generation cumulative value Pc is higher. Alternatively or additionally, the unit time may be shorter when the value of the heat generation cumulative value Pc is higher.

When the xenon flash tube 13 is activated, the temperature thereof rises in proportion to the intensity of the emitted flash light. When the xenon flash tube 13 is not activated, the temperature of the xenon tube decreases with the elapsing of time. Therefore, by adding the heat generation value Pa and subtracting the heat dissipation value Pb to and from the heat generation cumulative value Pc, the heat generation cumulative value Pc can be fairly accurately associated with the temperature of the xenon flash tube 13 without regard to the functional modes in which the flash device is used as long as the heat generation value Pa and the heat dissipation value Pb are appropriately defined.

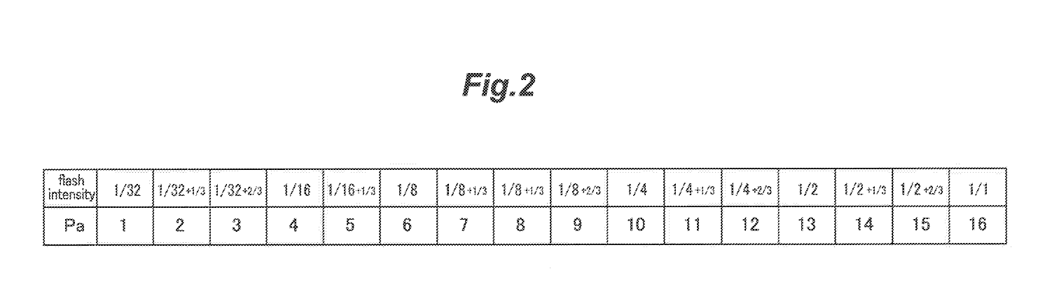

The heat generation value Pa and the heat dissipation value Pb can be determined either by experiment or by heat analysis, and the heat generation value accumulating unit 44 may be provided with a data table associating the heat generation value Pa with the intensity of the flash light as shown in FIG. 2, for example. In FIG. 2, light intensity 1/1 corresponds to a full main flash, and light intensity 1/22 corresponds to a maximally limited flash.

The heat dissipation value Pb may consist of a fixed value for each unit time interval so that the heat generation cumulative value Pc may be decremented by a prescribed value (the heat dissipation value Pb) upon elapsing of each unit time when the xenon flash tube 13 is in anon-active state.

The heat generation limit control unit 42 compares the heat generation cumulative value Pc with the prescribed value Pset, and prohibits the emission of flash light from the xenon discharge tube 13 when the heat generation cumulative value Pc exceeds the prescribed value Pset. Thereby, the xenon discharge tube 13 is prevented from an excessive temperature rise, and is protected from thermal damages.

Optionally, the heat generation limit control unit 42 may also forward a signal to the camera 50 to increase the sensitivity of the camera 50 by one level when the heat generation cumulative value Pc reaches the prescribed value Pset. By increasing the sensitivity of the camera 50, the need for flash light may be reduced, and the chance of the camera to be able to take pictures without the help of the flash light may be increased. At any event, the frequency of prohibiting the flash light or the time duration of prohibiting the flash light would be reduced.

After the heat generation cumulative value Pc has fallen below the prescribed value Pset, if the heat generation cumulative value Pc reaches the prescribed value Pset once again within a prescribed time period, the sensitivity of the camera 50 may be increased by an additional level. Conversely, if the heat generation cumulative value Pc remains below the prescribed value Pset for a prescribed period of time, the sensitivity of the camera 50 may be decreased by a prescribed level. If the heat generation cumulative value Pc remains below the prescribed value Pset for a long enough period of time, the sensitivity of the camera 50 will be brought back to the original normal value.

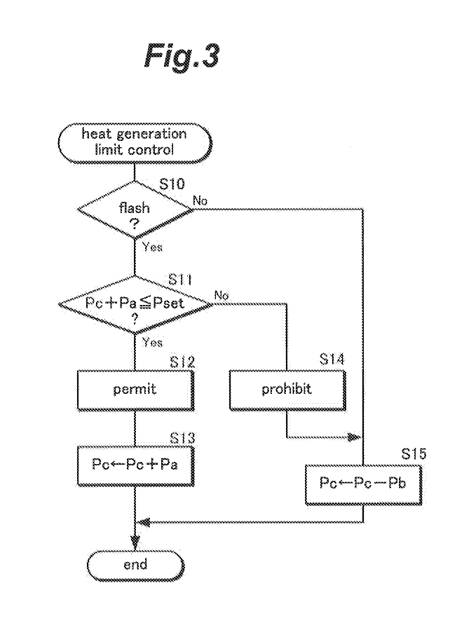

A heat generation limit control routine performed by the heat generation limit control unit 42 and the heat generation value accumulating unit 44 is described in the following with reference to the flow chart of FIG. 3. The heat generation limit control routine is executed as a software interrupt routine which is repeated at a prescribed time interval.

First of all, it is determined if a flash light emission command is received from the camera 50 (step S10). If there is no flash light emission command, upon elapsing of a prescribed period of time without any flash light emission, the heat generation cumulative value Pc is decremented by the heat dissipation value Pb (step S15). Then, this particular execution cycle of this routine is concluded.

If a flash light emission command is detected in step S10, the heat generation value Pa corresponding to the succeeding flash light emission is read out from the data table, and is added to the heat generation cumulative value Pc. Additionally, it is determined if the sum of the heat generation value Pa and the heat generation cumulative value Pc is no more than the prescribed value Pset (step S11).

If (Pc+Pa) is more than Pset, as it means that the temperature of the xenon discharge tube 13 will reach an unacceptable level, a flash light prohibition command is forwarded to the light emission control unit 40 (step S14). As a result, the xenon discharge tube 13 is prevented from being activated, and the heat generation cumulative value Pc is decremented by the heat dissipation value Pb in step S15 before concluding the particular execution cycle of this routine.

On the other hand, if (Pc+Pa) is no more than Pset in step S11, as it means that the temperature of the xenon discharge tube 13 will be within an acceptable range, a flash light permission command is forwarded to the light emission control unit 40 (step S12). As a result, the xenon discharge tube 13 is allowed to be activated, and the heat generation cumulative value Pc is incremented by the heat dissipation value Pb corresponding to the anticipated emission of flash light in step S13 before concluding the particular execution cycle of this routine.

By repeating this routine at a regular interval, the heat generation cumulative value Pc is prevented from increasing beyond the prescribed limit value Pset so that the temperature of the xenon discharge tube 13 is kept within an acceptable range at all times. When the flash device is not activated for a long enough period of time, the heat generation cumulative value Pc will reach a default value (which may be zero), and does not fall any further even though the xenon discharge tube 13 may continue to be unused.

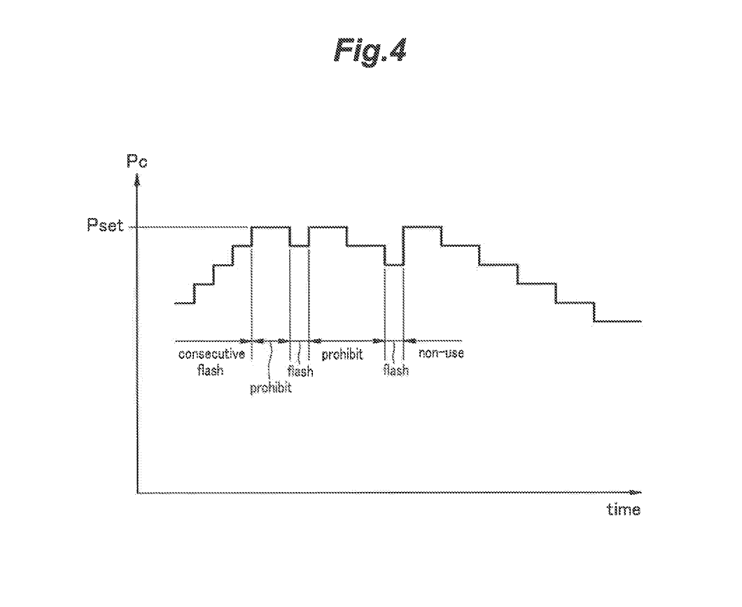

FIG. 4 shows a typical pattern of changes in the heat generation cumulative value Pc. Initially, the heat generation cumulative value Pc sharply increases owing to the consecutive emission of flash light. Once the heat generation cumulative value Pc reaches the prescribed limit value Pset, the any further emission of flash light is prohibited, and the flash tube is allowed to cool off. As soon as the heat generation cumulative value Pc falls below the prescribed limit value Pset, emission of flash light is permitted once again. This process is repeated thereafter.

The heat generation cumulative value Pc stored in the heat generation value accumulating unit 44 may be retained even after the flash device 10 is powered off. The flash device continues to operate under a power saving mode, and the heat generation cumulative value Pc is allowed to be decremented by the heat dissipation value Pb upon elapsing of each unit time until the heat generation cumulative value Pc drops to the default value. Therefore, even when the flash device is powered up immediately after being powered off, the temperature of the flash tube 13 is continued to be monitored so that the flash tube 13 continues to be protected from heat.

Alternatively, after the flash device 10 is powered off, the heat generation cumulative value Pc stored in the heat generation value accumulating unit 44 may be retained until the voltage of the main capacitor has dropped below a prescribed level. If the flash device is powered up again before the voltage of the main capacitor has dropped below the prescribed level, the heat generation limit control is resumed with the heat generation cumulative value Pc stored in the heat generation value accumulating unit 44. Once the voltage of the main capacitor has dropped below a prescribed level, the heat generation value accumulating unit 44 may be reset to the initial default condition.

Although the present invention has been described in terms of a preferred embodiment thereof, it is obvious to a person skilled in the art that various alterations and modifications are possible without departing from the scope of the present invention which is set forth in the appended claims. The contents of the original Japanese patent application on which the Paris Convention priority claim is made for the present application as well as the contents of the prior art references mentioned in this application are incorporated in this application by reference.

1. An electronic flash device, comprising:
a flash unit including a flash tube for emitting flash light;
a flash control unit configured to receive information from a camera and control the flash unit according to the information received from the camera;
wherein the flash control unit includes a heat generation value accumulating unit storing a heat generation accumulated value and configured to increment the heat generation accumulated value by each activation of the flash unit and decrement the heat generation accumulated value by elapsing of each unit time, and a heat generation limit control unit configured to permit an activation of the flash unit when the heat generation accumulated value is no more than a prescribed value and prohibit an activation of the flash unit when the heat generation accumulated value is more than the prescribed value.

2. The electronic flash device according to claim 1, wherein the heat generation value accumulating unit is configured to increment the heat generation accumulated value by each activation of the flash unit by an incremental value corresponding to an intensity of the particular activation of the flash unit.

3. The electronic flash device according to claim 2, wherein the heat generation value accumulating unit is provided with a data table associating the intensity of the activation of the flash unit with a corresponding incremental value.

4. The electronic flash device according to claim 1, wherein the heat generation limit control unit is configured to forward a signal to the camera to change a sensitivity of the camera depending on the heat generation accumulated value.
